(19) United States
(12) Patent Application Publication
(10) Pub. No.: US 2021/0160290 A1
(43) Pub. Date: May 27, 2021

(54) Computer-implemented method of performing a communication and collaboration session and communication and collaboration system

(71) Applicant: Unify Patente GmbH & Co. KG, München (DE)

(72) Inventors: Jürgen Brieskorn, Geltendorf (DE); Charalampos Grigoropoulos, Chalandri (GR); Bruce M. Skeldon, Wellington, FL (US)

(21) Appl. No.: 16/697,813

(22) Filed: Nov. 27, 2019

(51) Int. Cl. H04L 29/06; H04L 12/58; H04L 29/08

(52) U.S. Cl. CPC H04L 65/403; H04L 65/1093; H04L 67/36; H04L 51/04; H04L 65/1069; H04L 65/1089

(57) ABSTRACT

A method and apparatus for performing a communication and collaboration session. The performance of the session can include a first participant selecting, during the ongoing communication and collaboration session, a second participant of the communication session with whom a follow-up conversation needs to be held after the termination of the ongoing communication and collaboration session and sending, during the ongoing communication and collaboration session, a notification about the intended follow-up conversation to the second participant. After the session is terminated, a communication line between the first participant and the second participant can be automatically established. A communication server that can host the session and support the automatic establishment of the follow-up conversation communication connection can be incorporated into a system or apparatus that can utilize an embodiment of the method.

### FIELD

The present invention relates to a computer-implemented method of performing a communication and collaboration session as well as a communication and collaboration system and a communication apparatus. The apparatus and system can be configured to implement an embodiment of the method.

### BACKGROUND

Nowadays, telephone conferences or communication and collaboration sessions in which a plurality of users who are located at different places communicate via the Internet in real-time are rather common. However, many times, during such a session or at the end of a web collaboration meeting, a participant may decide that he or she would like to talk privately with another meeting member immediately after the session. For example, something might have been brought up during the session that a participant would like to discuss with another specific participant of the communication and collaboration session in a more casual talk and without the stressful situation that all other participants will be listening too hence, preventing the openness of the conversation.

Further, specifically at the end of such a meeting, usually the participants are busy saying goodbye to the other participants, so that it might be rather difficult to inform another participant on the wish to further discuss an issue of the session in a subsequent one-on-one call.

### SUMMARY

Thus, with respect to communication and collaboration systems known from prior art, we have identified a problem related to the continuing of a discussion of a communication and collaboration session in which a plurality of users have participated immediately after the session has terminated in a one-on-one call with a specifically selected specific user. No technical procedure is known for this situation, and thus, a user has to manually call back another participant of a communication session for a one-on-one talk after terminating the communication session manually. Also, usually the participants of a communication and collaboration session will rather decide to have a break after termination of the session so that a call to another participant for further discussion might be delayed, which in turn might cause that some items to be discussed might be forgotten at the later point of time when the one-on-one call eventually takes place after the break.

Therefore, we have determined that is a problem of facilitating an immediate subsequent one-on-one call between two specific participants of a communication and collaboration session with a plurality of participants. This problem can be solved by an embodiment of the inventive computer-implemented method of performing a communication and collaboration session with remotely located participants that we have developed. This problem can also be solved by implementation of an embodiment of a communication apparatus or a communication and collaboration system.

Accordingly, an embodiment of the computer-implemented method is provided according to the present invention, wherein a plurality of participants communicate with each other via a WebRTC communication and collaboration system comprising a communication server via which a plurality of clients used by the participants are connected to each other. The communication server can be a computer device having a processor connected to a non-transitory computer readable medium (e.g. memory). The server can have at least one interface for communicative connection to the clients. Each of the clients can be computer devices (e.g. smart phones, telephones, laptops, tablets, etc.) that have a processor that can run at least one application supported by the server that is stored in the memory of the computer device. The embodiment of the method can include the following steps:
(a) during the communication session, maintaining a plurality of communication lines between each client of the plurality of clients and a communication server,
(b) selecting, during the ongoing communication and collaboration session, by a first participant, a second participant of the communication session, with whom a follow-up conversation needs to be held after the termination of the ongoing communication and collaboration session,
(c) sending, during the ongoing communication and collaboration session, a notification about the intended follow-up conversation to the second participant;
(d) terminating the communication and collaboration session by separating all communication lines between each client of the plurality of clients and the communication server, and
(e) automatically establishing a communication line between the first participant and the second participant

According to a preferred embodiment of the invention, the notification sent by the first participant is displayed on a screen of the second participant's client in a pop-up window.

According to another preferred embodiment of the invention, the pop-up window can include a message concerning the follow-up conversation generated by the first participant or generated automatically.

According to another preferred embodiment of the invention, the sending of the notification can be initiated by the first participant via clicking on a button provided on a screen of the first participant's client. In some embodiments, the clicking of the button can be provided by a user pressing a touch screen on which the button is displayed or using a pointer device to provide the clicking input.

According to still another preferred embodiment of the invention, the follow-up conversation can be initiated by the first participant clicking on an avatar of the second participant. In some embodiments, the clicking of the avatar can be provided by a user pressing a touch screen on which the avatar icon is displayed or using a pointer device to provide the clicking input for actuating the avatar or avatar icon displayed on a screen of the first participant's device.

Embodiments of the method can also include other steps. For instance, an embodiment of the method can include verifying whether the second participant is sharing his or her screen with the other participants of the communication and collaboration session.

According to still a further preferred embodiment of the invention, if it is determined that the second participant is sharing his or her screen with the other participants of the communication and collaboration session, then instead of displaying the notification sent by the first participant on the second participant's screen, a short message can be sent to the second participant's private conversation. The short message can be a relatively short text content of a notification to be displayed to the recipient when the recipient is notified of the requested follow-up one on one session. In other embodiments, the short message can be incorporated into a text message or an instant message that is sent to the client of the intended recipient.

In some embodiments, the communication and collaboration session may be a telephone conference.

In some embodiments, a predetermined time period at the end of the communication and collaboration session can be recorded and the recorded text can be transcribed so as to be presented as an agenda in the follow-up conversation. The server can record the audio of the session and subsequently transcribe it for the follow-up conversation in receipt to a request received from a client that seeks to initiate the formation of such a follow-up conversation. In some embodiments, the time at which the session is recorded can be a time that occurs after receipt of this request or can be a time that includes a pre-selected time period prior to receipt of the request in addition to the time following receipt of the request.

Further, according to the present invention, a real time communication (RTC) based communication and collaboration system can include a communication server on which an application is running which is configured to carry out an embodiment of the computer-implemented method of performing a communication and collaboration session. A communication apparatus that includes such a communication server is also provided.

It should be appreciated that embodiments of the innovation can be configured so that a follow-up call can be automatically established with a participant of a Web-based communication and collaboration session with a plurality of participants. The participant may easily be selected by another participant of the session and be informed about the intended follow-up one-on-one conversation. This can facilitate collaboration procedures a private conversation may be held for further discussing open issues or the like immediately after the termination of a telephone conference or the like in which a specific item or topic has been discussed and worked on.

Other details, objects, and advantages of the telecommunications apparatus method will become apparent as the following description of certain exemplary embodiments thereof proceeds.

### BRIEF DESCRIPTION OF THE DRAWINGS

The invention and embodiments thereof will be described below in further detail in connection with the drawings. It should be understood that like reference characters used in the drawings may identify like components.

FIG. 1 shows a screen of a client's display with a notification for a one-on-one call according to an embodiment of the invention;

FIG. 2 shows a screen of a client's display according to another embodiment of the invention;

FIG. 3 shows a flowchart of the method for performing a communication and collaboration session according to an embodiment of the invention; and

FIG. 4 shows another flowchart of the method for performing a communication and collaboration session according to another embodiment of the invention.

### REFERENCE NUMERALS UTILIZED IN THE DRAWINGS INCLUDE

| | |
|---|---|
| 1 | Screen |
| 2 | Client |
| 3 | Web conference screen |
| 4 | Pop-up window |
| 5 | Button |
| 6 | Avatar |
| S1-S6 | Steps of a method |
| S1′-S4′ | Steps of a method |

### DETAILED DESCRIPTION OF EXEMPLARY EMBODIMENTS

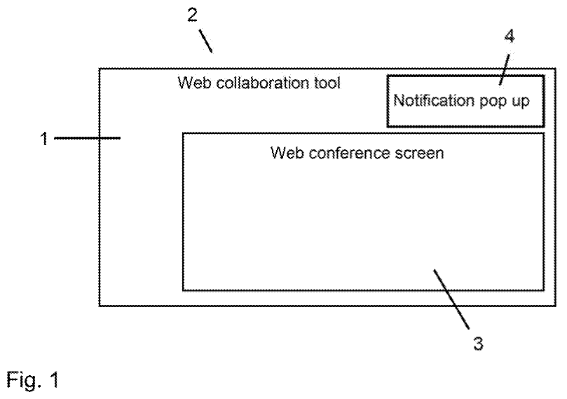

FIG. 1 shows a screen 1 of a display of a client 2 used by a participant of a communication and collaboration session to be notified on an intended one-on-one call by another participant of the communication and collaboration session according to an embodiment of the invention. As can be seen, the screen 1 is subdivided into a web conference screen 3, on which content is shared during a communication and collaboration session via the Internet, via at least one network. The content may be, for example, provided by a moderator of the session who shares his or her screen with the other participants of the communication and collaboration session. The web conference screen 3 is smaller than the entire screen area, so that in the background, a web collaboration tool may be displayed for the user, for example, so as to be able to use functions of the web collaboration platform during the communication and collaboration session running on the latter. Also, as can be seen on the upper right hand side of the screen 1, a notification pop up window 4 is shown, which is displayed as another user triggers this notification and call-back function for an intended one-on-one call with that participant.

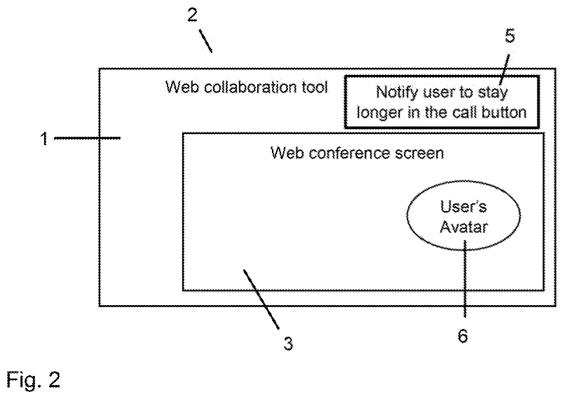

FIG. 2 shows another screen 1 of a display of another client 2 used by another participant of the communication and collaboration session, whereby the participant of the client 2 wants to make a one-on-one call with another participant after the communication and collaboration session has ended. The other participant can be notified about the intended call as outlined with respect to FIG. 1.

Thus, in the following, exemplary options are described of how to trigger the notification and call-back function and of continuing a discussion of a web collaboration and communication session in a subsequent private meeting or call between two participants from a plurality of participants, respectively, is described.

According to a first exemplary option, a button 5 is provided on the screens of the display devices of the clients as an icon or button image of the user interface displayed on the screen 1. The client 2 is connected to a server (e.g. a media server, a teleconference server, a web-conference hosting server, etc.) on which the communication and collaboration application is running so that a first participant who participates in a multi-participant communication and collaboration session and who decides to further discuss a specific item of the session with a second participant of the session may simply actuate the button 5 displayed on the user interface shown on the screen 1 for triggering a notification to be sent to a second participant of the session that informs him or her that a subsequent one-on-one conversation is intended immediately after termination of the communication and collaboration session. The actuation of the button 5 can be provided by use of an input device (e.g. pointer device or touch screen) to actuate the button by selecting the button to actuate it and initiate sending of the request for the one-on-one communication session to the server to cause the server to have the notification communicated to the screen 1 of the intended recipient. As already described above, upon actuation of the button 5, a pop up window 4 (see FIG. 1) comprising the notification concerning the follow-up call with this participant will appear on the screen 1 of his or her client. It should be appreciated that the server hosting the communication and collaboration session can communicate with the client 2 to have the pop up window 4 displayed on the screen 1 in response to receipt of a request for such a session that is received from a client 2 due to the actuation of the button 5 displayed on the other user's screen 1 during the session.

The first participant, namely, the requestor may have at least three options to choose from concerning the notification pop up window 4 comprising a notification message to be received by the selected second participant. These options can include:

I. Manually write a short message explaining why the conversation after the communication and collaboration session is requested and what will be discussed in the subsequent one-on-one call.

II. Use transcription methods that for example, add automatically, the last two minutes of the conference conversation so as to keep this as a sort of agenda for the subsequent one-on-one discussion that will follow the initial communication and collaboration session.

III. Add some automatically suggested ‘strong key words’ which will be captured by a web collaboration tool using transcription methods while writing the short message to the second participant to talk to in private in the subsequently held one-on-one session. Examples of such strong words could be: (1) “bug”, (2) “version problem” and in general words that are repeated most of the times in the conversation up to the point that a user chooses the option to send the notification. Upon termination of the initial multi-participant communication and collaboration session, an automatic call back may be generated between the requestor and the requested party so that the private conversation may start. The communication server hosting the multi-participant session can facilitate the automatic call back directly or by requesting the call-back be initiated by another communication server (e.g. a PBX or other communication server associated with clients of the users to be included in the one-on-one session).

However, if the selected second participant of the subsequent one-on-one meeting or call is a user who shares a screen 1 with the other participants of the communication and collaboration session, no notification pop up will be sent to his screen as this would reveal the identity of the subsequent one-on-one conversation requested to the other people included in the session. Instead, an automatic message will be posted in a private conversation between the requestor and the requestee with no notification pop up being sent. Such a private conversation can be provided by a text message or instant message exchanged between the clients of the requester and requestee. Also in this case, it should be appreciated that an automatic call back will be placed when the initial multi-participant communication and collaboration session is terminated.

According to a second option, a participant may be kept in a meeting or informed on a subsequent follow-up one-on-one call by touching an avatar 6 of the user. The avatar 6 of the user can be an icon or other graphic displayed on a user interface shown on the screen 1 that represents a particular user. When the one-on-one meeting requestor touches the avatar 6 of one of the participants at the end of the meeting (e.g. use of a touch screen interface to select the avatar 6 by touching the portion of the screen on which the avatar 6 is displayed, use of a pointer device to select the displayed avatar 6, etc.), the requestor can “force” him/her to stay in the conference call session for a few more minutes after the session is terminated so that issues can be discussed in a one-on-one session after the group session involving other users is terminated and those other users are dropped from the session. Actuation of the avatar 6 would generate a notification towards the other party that there is a request to stay in the meeting for some more time. However, the requestee would still be able to drop the call in case there is a need to immediately join a new conference or go to another meeting. Again, as already described above, upon touching the avatar, a pop up window 4 comprising the notification concerning the follow-up call with this participant will appear on the screen of his or her client. But, in this option, the follow-up call can be staying in the session after it is terminated instead of participating in a newly established one-on-one session.

According to a third option, the participant who has been selected by another participant during a communication and collaboration session for a follow-up one-on-one call right after the ongoing communication and collaboration session will be automatically called as soon as the multi-participant communication and collaboration session has terminated. At the time of terminating the conference when all of the participants are saying goodbyes to one another, as soon as the requestor asks another participant selected for a follow-up one-on-one call and in case this participant does not respond to this request, then, after the conference is over, a call back will be placed immediately and automatically.

Thus, summarizing the above, the method according to an embodiment of the invention will automatically call back the requestee when specific factors are met:

There will be a separate button 5 at the screen 1 of each participant having a particular label (e.g. a button 5 that is called “Auto ping participant”) that, when actuated during a conference, will send a notification to the requested party that a member of the conference wants to have a private conversation after the meeting. To ensure privacy of the notification and somehow protect both the requestor and the requested parties from other conference participants looking at this request when screen sharing is involved there can be be no pop up notification 4 and only a short message in the requested party's private conversation with the requestor (see FIG. 2).

At the end of the conference call when participants have started leaving the meeting, the opportunity may be provided to each participant of the communication and collaboration session to touch the avatar of a participant selected for a follow-up call, and make him stay for a little longer. By the time the avatar 6 of a selected participant is touched, then automatically a notification will pop up in a pop-up window 4 on the screen 3 of this participant's client that another participant requires him/her to stay for a few more minutes. There will, of course, be the possibility for this participant to leave the conference by pressing once more the hang up button upon reception of the notification/During the communication and collaboration session, the application running on the server may capture phrases like: “<participant's name> can you stay a little longer on the call?”, “<participant's name> do you have five more minutes?” and using the participant's name variable if the participant has left the call upon these requests because he/she was not able to hear them then it will automatically call him/her back.

It is noted that in general, the method described above can enable an enhanced collaboration between parties, especially when they are not located at the same geographical location (e.g. are remotely located at separate buildings or facilitates in different locations). It can facilitate and improve the communication and collaboration since topics that might be forgotten if a user was not responding to a request for an immediate follow-up discussion are now going to be addressed in a more efficient manner.

It should be understood that the server hosting the communication and collaboration session and participant devices facilitating their involvement in such a session are communication devices. These devices are machines that include hardware. The server can be a computer device having a processor connected to a non-transitory computer readable medium (e.g. memory) that has an application stored thereon that is executed by the processor to facilitate the hosting of the session and facilitating the use of button 5 or avatar 6 and the related notifications for requesting and subsequently facilitating the follow-up one-on-one communication session. The participant devices can also be computer devices (e.g. smart phones, laptop computers, etc.) that have a processor connected to a non-transitory memory. The participant devices can be configured to communicatively connect to the server to utilize the session hosted by the server. Each of these devices can include at least one interface for a network connection to facilitate utilization of the session hosted by the server, for example.

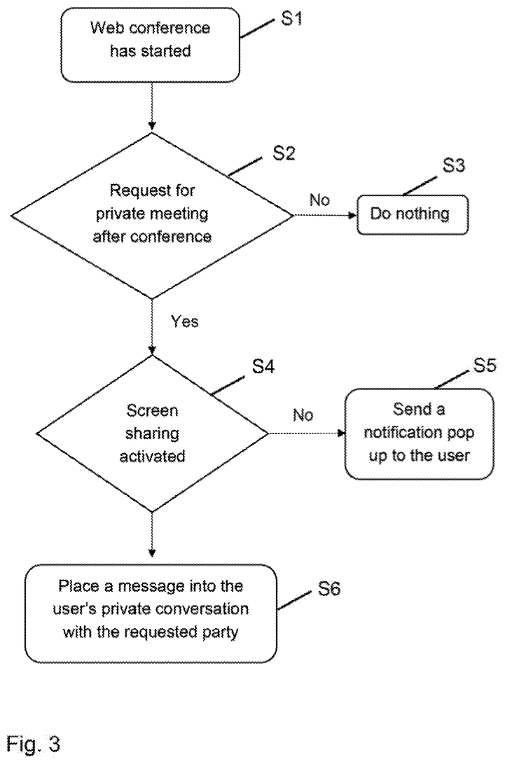

FIG. 3 shows a flowchart of an exemplary method for performing a communication and collaboration session according to an embodiment of the invention. In a first step S1, the communication and collaboration session is started, wherein a plurality of participants connect with their respective clients 2 to a web server or media server, on which a communication and collaboration application is running. In a second step S2, a first participant of the plurality of participants of the communication and collaboration session may feel that he or she would like a topic of the session or something else in a private follow-up one-on-one call with another second participant of the communication and collaboration session, then the first participant will trigger a request for a private meeting after the conference as already outlined with respect to FIG. 1. If there is no need for a private meeting, then the communication and collaboration session continues without any additional steps as shown in step S3. If the first participant, however, has decided to hold a subsequent private meeting with a selected second participant, then in step S4 it is verified whether the second participant is currently sharing his or her screen. If negative, then in step S5, a notification will be sent to the second participant triggered by the first participant as outlined with respect to FIG. 1 (for example, according to the first option), which will then appear in a pop-up window on the screen of the second participant's client that will inform him about the requested private follow-up one-on-one conversation after the current multi-participant communication and collaboration session has terminated. If the selected second participant is sharing his or her screen during the session when the notification is to be sent, the notification will not be displayed on the user's shared screen. Instead, the server will have the notification included in a private message sent from the requester to the selected participant (e.g. a text message or instant message) in an alternative step S6 to protect the privacy of these participants.

As it is obvious from the procedure described above, privacy considerations with this methodology can be avoided as the methodology can be implemented so that no personal data is exposed to other users or participants. In any case, the one-on-one follow-up conversation feature can also be configurable per user and will only be activated once the user gives his/her permission.

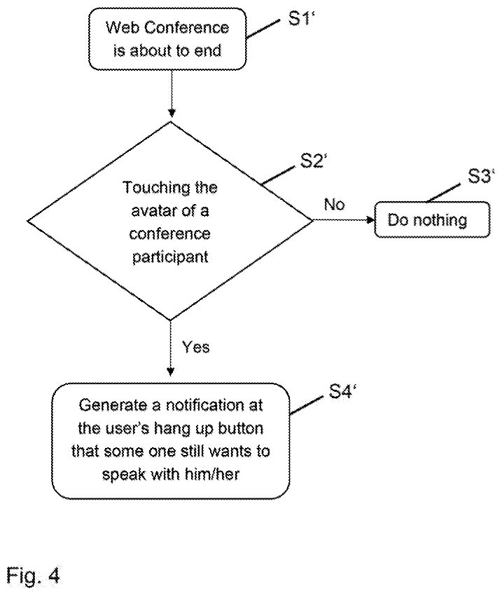

FIG. 4 shows another flowchart of an embodiment of the method for performing a communication and collaboration session. During an ongoing communication and collaboration session, it is verified that the latter is about to end (S1). Then a first participant may decide to touch or otherwise actuate an avatar 6 of a second participant with whom he or she would like to further discuses one or more issues of the topic discussed in the ongoing multi-participant communication and collaboration session in a step S2′. If the first participant, however, does not have any need for further discussion and does not actuate the avatar of a selected second participant, then the ongoing session will continue and terminate without any further additional steps (S3′). If the first participant has decided to hold a follow-up discussion with a selected second participant by actuating the avatar 6 of the second participant, then in a step S4′, a notification will be generated at the second participant's hang up button displayed on the screen of his or her client comprising an indication that the first participant would like to hold a one-on-one call after termination of the ongoing communication and collaboration session. The second participant can then accept that follow-up one-one-one communication connection or refuse it depending on his or her schedule. In another alternative, the second participant can be informed of the one-on-one session request prior to termination of the multiparticipant session and subsequently be kept in the session after other users are dropped from the session so that the session continued after its termination as a one-on-one conversation as requested by the first participant.

It should be appreciated that different embodiments of the method, system, and apparatus can be developed to meet different sets of design criteria. For example, the particular type of network connection, server configuration or client configuration for use in embodiments of the method can be adapted to account for different sets of design criteria. As yet another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a network, a server that can host a communication and collaboration session, a telecommunications apparatus and methods of making and using the same have been shown and described above, it is to be distinctly understood that the invention is not limited thereto but may be otherwise variously embodied and practiced within the scope of the following claims.

What is claimed is:

1. A computer-implemented method of performing a communication and collaboration session, wherein a plurality of participants communicate with each other via a WebRTC communication and collaboration system comprising a communication server via which a plurality of clients used by the participants are connected to each other, the method comprising the following steps:
during the communication session, maintaining a plurality of communication lines between each client of the plurality of clients and a communication server,
selecting, during the ongoing communication and collaboration session, by a first participant, a second participant of the communication session, with whom a follow-up conversation needs to be held after the termination of the ongoing communication and collaboration session,
sending, during the ongoing communication and collaboration session, a notification about the intended follow-up conversation to the second participant;
terminating the communication and collaboration session by separating all communication lines between each client of the plurality of clients and the communication server, and
automatically establishing a communication line between the first participant and the second participant.

2. The computer-implemented method according to claim 1, wherein the notification sent by the first participant is displayed on a screen of the second participant's client in a pop-up window.

3. The computer-implemented method according to claim 2, wherein the pop-up window comprises a message concerning the follow-up conversation generated by the first participant or generated automatically.

4. The computer-implemented method according to claim 1, wherein the sending of a notification is initiated by the first participant by clicking on a button provided on a screen of the first participant's client.

5. The computer-implemented method according to claim 1, wherein the follow-up conversation is initiated by the first participant by clicking on an avatar of the second participant.

6. The computer-implemented method according to claim 1, wherein the method further comprises a step of verifying whether the second participant is sharing his or her screen with the other participants of the communication and collaboration session.

7. The computer-implemented method according to claim 6, in response to determining that the the second participant is sharing his or her screen with the other participants of the communication and collaboration session, the notification is sent as a message from the first participant to the second participant as a private conversation to avoid notification of the intended follow-up conversation being displayed on the shared screen.

8. The computer-implemented method according to claim 1, wherein the communication and collaboration session is a telephone conference.

9. The computer-implemented method according to claim 1, wherein a predetermined time period at the end of the communication and collaboration session is recorded, and the recorded text is transcribed so as to be presented as an agenda in the follow-up conversation.

10. A communication and collaboration system comprising a communication server having a processor and a non-transitory computer readable medium having an application stored thereon, the application defining a method that is performed when the application is run by the processor, the method comprising:
during the communication session, maintaining a plurality of communication lines between each client of the plurality of clients and a communication server,
sending, during an ongoing communication and collaboration session, a notification about an intended follow-up conversation to a second participant in response to receiving a request for the intended follow-up conversation from a first participant during the ongoing communication and collaboration session,
terminating the communication and collaboration session by separating all communication lines between each client of a plurality of clients and the communication server, and
automatically establishing a communication line between the first participant and the second participant after the communication and collaboration session is terminated in response to the receipt of the request for the intended follow-up conversation from the first participant.

11. The communication and collaboration system of claim 10, comprising:
the clients communicatively connectable to the communication server.

12. The communication and collaboration system of claim 11, wherein each of the clients includes a processor connected to a non-transitory computer readable medium.

13. The communication and collaboration system of claim 10, wherein the method further comprises the communication server verifying whether the second participant is sharing his or her screen with other participants of the communication and collaboration session, and
in response to determining that the the second participant is sharing his or her screen with the other participants of the communication and collaboration session, sending the notification as a message from the first participant to the second participant included in a private conversation between the first participant and the second participant to avoid notification of the intended follow-up conversation being displayed on the shared screen.

14. The communication and collaboration system of claim 13, wherein the message of the private conversation is a text message or an instant message.
